(19) United States
(12) Patent Application Publication
(10) Pub. No.: US 2025/0278925 A1
(43) Pub. Date: Sep. 4, 2025

(54) ELECTRONIC DEVICE, OPERATING METHOD THEREOF, AND ELECTRONIC SYSTEM

(71) Applicant: SAMSUNG ELECTRONICS CO., LTD., Suwon-si (KR)

(72) Inventors: Jeongheon Kim, Suwon-si (KR); Kijeon Nam, Suwon-si (KR); Soon Gyu LEE, Suwon-si (KR); Youngjae Kim, Suwon-si (KR); Kyounghoon KANG, Suwon-si (KR); YOUNGHAK LEE, Suwon-si (KR)

(73) Assignee: SAMSUNG ELECTRONICS CO., LTD., Suwon-si (KR)

(21) Appl. No.: 18/910,715

(22) Filed: Oct. 9, 2024

(30) Foreign Application Priority Data
Mar. 4, 2024 (KR) 10-2024-0030840

(51) Int. Cl. G06V 10/774; G06V 10/72; G06V 10/764; G06V 10/94; G06V 20/69

(52) U.S. Cl. CPC G06V 10/774; G06V 10/72; G06V 10/764; G06V 10/945; G06V 20/698

(57) ABSTRACT

An electronic device includes: a memory configure to store a first training dataset labeled with a defect shape and a mask pattern of a mask and at least one artificial intelligence model; and at least one processor configured to receive defect data including first defect data, second defect data, and third defect data; by using the second defect data, obtain a second training dataset by performing data augmentation on a defect shape for which an amount of labeled data in the first training dataset is determined to be less than a threshold value; train a first artificial intelligence model generated to classify a defect type of the mask based on the first training dataset and the second training dataset; and classify a defect type of the mask based on at least one of the first defect data, the third defect data, or the first artificial intelligence model.

### CROSS-REFERENCE TO RELATED APPLICATION

This application claims priority to and the benefit of Korean Patent Application No. 10-2024-0030840 filed in the Korean Intellectual Property Office on Mar. 4, 2024, the entire contents of which are herein incorporated by reference.

### BACKGROUND

### 1. Field

One or more example embodiments of the disclosure relate to an electronic device, an operating method of the electronic device, and an electronic system.

### 2. Description of the Related Art

In recent years, as the patterns being implemented on wafers have become finer, controlling defects that may occur on a mask has become important. In the related art, operators perform visual analysis of all defect images to detect mask defects at an early stage, but this method is time-consuming and there may be inconsistent analysis results between operators.

Therefore, an automatic defect classification process may be performed to control defects that may occur on the mask. In the related art, defect classification has been performed using methods, such as Convolutional Neural Network (CNN) or K-Nearest Neighbor (K-NN) algorithms. However, with the introduction of Extreme Ultraviolet Lithography (EUV) process, the process has become more sophisticated, requiring a more reliable automatic defect classification process.

### SUMMARY

The disclosure attempts to provide an electronic device, an operating method of the electronic device, and an electronic system that automatically classify types of defects that may occur on a mask.

An embodiment of the disclosure provides an electronic device including: a communication circuit; a memory configured to store a first training dataset and at least one artificial intelligence model, the first training dataset being labeled with a defect shape and a mask pattern of a mask; and at least one processor operatively connected to the communication circuit and the memory, wherein the at least one processor is configured to receive, from an external database via the communication circuit, defect data obtained from at least one facility, the defect data including first defect data, second defect data, and third defect data; by using the second defect data, obtain a second training dataset by performing data augmentation on a defect shape for which an amount of labeled data in the first training dataset is determined to be less than a threshold value; train a first artificial intelligence model generated to classify a defect type of a mask based on the first training dataset and the second training dataset; and classify a defect type of the mask based on at least one of the first defect data, the third defect data, or the first artificial intelligence model.

Another embodiment of the disclosure provides an operating method of an electronic device, the operating method including: receiving, via a communication circuit, defect data obtained from at least one facility from an external database, the defect data including first defect data, second defect data, and third defect data; by using the second defect data, obtaining a second training dataset by performing data augmentation on a defect shape for which an amount of labeled data in the first training dataset is determined to be less than a threshold value; training a first artificial intelligence model generated to classify a defect type of a mask based on the first training dataset and the second training dataset; and classifying a defect type of a mask based on at least one of the first defect data, the third defect data, or the first artificial intelligence model.

Still another embodiment of the disclosure provides an electronic system including: an electronic device including a processor, a memory, and a communication circuit; at least one inspection facility configured to inspect a defect related to a mask; and a semiconductor process facility configured to perform a process based on mask defect information, in which the electronic device is configured to predict a defect type of a mask based on at least one of manufacturing process data of the mask received from the at least one inspection facility or an artificial intelligence model trained to classify a defect type of the mask, and transmit defect prediction data for the predicted defect type to the semiconductor process facility, and the semiconductor process facility is configured to perform a process according to the defect prediction data.

According to an example embodiments, automated defect classification is performed by utilizing process data other than scanning electron microscope (SEM) and/or graphic design system (GDS) images, thereby improving reliability and productivity.

According to an example embodiments, sufficient data required for defect classification is secured through data augmentation, thereby improving the accuracy of defect classification.

### BRIEF DESCRIPTION OF THE DRAWINGS

The above and other aspects, features, and advantages in the example embodiment will be more clearly understood from the following detailed description, taken in combination with the accompanying drawing.

FIG. 1 is a block diagram of an electronic device control system according to an example embodiment.

FIG. 2 is a flowchart illustrating an operating method of an electronic device according to an example embodiment.

FIG. 3 is a block diagram of a program module executed by an electronic device according to an example embodiment.

FIGS. 4 to 7 are diagrams for illustrating operations of an electronic device according to an example embodiment.

FIG. 8 is a diagram illustrating an electronic system according to an example embodiment.

FIG. 9 is a drawing illustrating an example of a computer device implementing the electronic device according to an example embodiment.

### DETAILED DESCRIPTION

In the following detailed description, only certain example embodiments have been illustrated and described, simply by way of illustration. The disclosure may be variously implemented and is not limited to the following embodiments.

The drawings and description are to be regarded as illustrative in nature and not restrictive. Like reference numerals designate like elements throughout the specification.

In addition, a size and a thickness of each configuration illustrated in the drawings may be arbitrarily illustrated for understanding and ease of description, but the disclosure is not limited thereto. In the drawings, thicknesses of layers, films, panels, regions, etc., may be exaggerated for clarity. In the drawings, for understanding and ease of description, thicknesses of some layers and areas may be exaggerated.

Further, it will be understood that when an element such as a layer, film, region, or substrate is referred to as being “on” another element, it may be directly on the other element or intervening elements may also be present. In contrast, when an element is referred to as being “directly on” another element, there are no intervening elements present. Further, it will be understood that when an element such as a layer, film, region, or substrate is referred to as being “on” another element, it may be directly on the other element or intervening elements may also be present.

In addition, unless explicitly described to the contrary, the word “comprise”, and variations such as “comprises” or “comprising”, will be understood to imply the inclusion of stated elements but not the exclusion of any other elements.

Further, in the entire specification, when it is referred to as “in a plan view”, it means when a target part is viewed from above, and when it is referred to as “in a cross-sectional view”, it means when the cross-section obtained by cutting a target part vertically is viewed from the side.

In addition, the terms “ . . . er”, “ . . . or”, and “ . . . module” described in the specification mean units for processing at least one function and operation and may be implemented by hardware components or software components and combinations thereof. Further, a plurality of “ . . . modules,” a plurality of “ . . . units,” or a plurality of “ . . . modules” may be integrated into at least one module and implemented on at least one processor, except for “ . . . units,” “ . . . units,” and “ . . . modules,” which need to be implemented on specific hardware.

In the present specification, “transmit or provide” may include not only direct transmission or provision, but also indirect transmission or provision through another device or by utilizing a bypass path.

In the present specification, expressions in the singular form may be construed as either singular or plural, unless the explicit words “one” or “single” or the like are used.

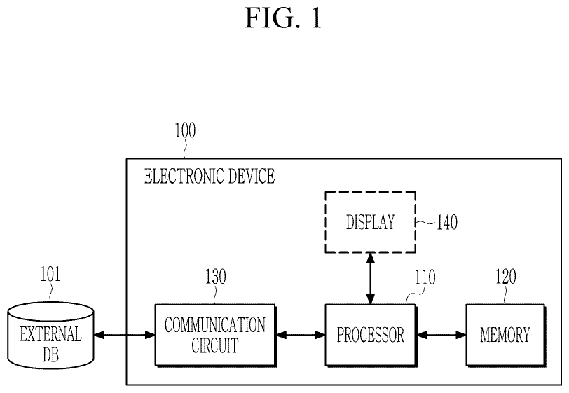

Hereinafter, an electronic device according to an example embodiment will be described with reference to FIG. 1.

FIG. 1 is a block diagram of an electronic device according to an example embodiment.

Referring to FIG. 1, an electronic device 100 according to an example embodiment may include at least one processor 110, a memory 120, a communication circuit 130, and a display 140. In some embodiments, the electronic device 100 may omit at least one of components described above (for example, the display 140) or may additionally include other components (for example, an input device).

The at least one processor 110 may be operatively connected to the memory 120, the communication circuit 130, and the display 140. The processor 110 may control the operation of the electronic device 100 by controlling at least one component of the electronic device 100 connected to the processor 110.

The processor 110 may execute instructions stored in the memory 120. The processor 110 may execute one or more applications stored in the memory 120.

Each application may include a set of instructions. By executing the instructions stored in the memory 120, the processor 110 may cause the electronic device 100 to perform the operations described herein. The operations described herein as being performed by the processor 110 may be understood to be performed by the electronic device 100, as the operations may be performed by the processor 110 and/or by at least one component of the electronic device 100 connected to the processor 110.

According to an example embodiment, the memory 120 may store data used or received by at least one component of the electronic device 100 (for example, the processor 110 and/or the communication circuit 130). The memory 120 may store instructions that are executed by the at least one processor 110. For example, the memory 120 may store information about a defect type of a mask that has been predicted (or classified) by the processor 110. According to an example embodiment, the defect type of the mask stored in the memory 120 may serve as reference data when a labeling operation is performed by a user (for example, an operator) after the defect type is stored.

According to an example embodiment, the memory 120 may store data that is transceived via the communication circuit 130. For example, the memory 120 may store defect data received via the communication circuit 130. According to an example embodiment, the defect data may be obtained from a server, a web storage, or an external storage device (for example, an external database 101, or an external memory card) and stored in the memory 120. Specifically, the memory 120 may store defect data received from the external database 101 (for example, facility database (facility DB)) via the communication circuit 130.

According to an example embodiment, the memory 120 may store defect data obtained from at least one facility. According to an example embodiment, the defect data may include first defect data, second defect data, and/or third defect data obtained from a separate facility. The second defect data may be obtained from a mask from which the first defect data was obtained and at least one unit process was performed thereon. Further, the third defect data may be obtained from a mask from which the second defect data was obtained and at least one unit process was performed thereon.

For example, the memory 120 may store at least one of the first defect data obtained from a raw material (for example, quartz), the second defect data obtained from the mask on which a patterning process was performed, or the third defect data obtained from the mask on which a repair process was performed.

According to an example embodiment, the memory 120 may store one or more artificial intelligence models (or neural network models) and a set of training data. The one or more artificial intelligence models may include artificial intelligence models that perform learning by classification among various learning methods of deep learning or machine learning. For example, the one or more artificial intelligence models may include a first artificial intelligence model trained to classify the defect type of the mask using training data.

The training dataset may be a training dataset utilized to train the artificial intelligence model. For example, the training dataset may include image data labeled with labels indicative of defect shapes and mask patterns.

The communication circuit 130 may support establishing a wired or wireless communication channel between the electronic device 100 and an external electronic device, and performing communication over the established communication channel. The processor 110 may obtain defect data from a cloud server, a web storage, or an external storage device (for example, the external database 101 and an external memory card) via the communication circuit 130.

The processor 110 may receive, via the communication circuit 130, defect data obtained during a mask manufacturing process from the external database 101 (for example, a facility database (facility DB)). The external database 101 may store data obtained from at least one defect inspection facility. For example, the external database 101 may store at least one of the first defect data obtained from the raw material (for example, quartz), the second defect data obtained from the mask on which the patterning process has been performed, or the third defect data obtained from the mask on which the repair process has been performed.

According to an example embodiment, the external database 101 may receive the first defect data from a first inspection facility corresponding to a raw material inspection facility, the second defect data from a second inspection facility inspecting masks on which a patterning process has been performed, and the third defect data from a third inspection facility inspecting masks on which a repair process has been performed.

According to an example embodiment, the communication circuit 130 may include a wireless communication module (for example, a cellular communication module, a near field communication module, or a global navigation satellite system (GNSS) communication module) or a wired communication module (for example, a local area network (LAN) communication module, or a power line communication module).

According to an example embodiment, the processor 110 may communicate with external electronic devices via a first network (for example, a short-range communication network such as Bluetooth, WiFi direct, or infrared data association (IrDA)) and/or a second network (for example, a long-range communication network such as a cellular network, the Internet, or a computer network (for example, LAN or WAN)) by using the communication circuit 130. Various types of communication circuit 130, including those described above, may be implemented on a single chip, or may be implemented as separate chips, respectively.

According to an example embodiment, the display 140 may display information that is processed on the display 140 under the control of the processor 110. For example, the display 140 may display various content (for example, text, images, video, icons, and/or symbols). According to an example embodiment, the display 140 may include a liquid crystal display (LCD), a light-emitting diode (LED) display, or an organic light-emitting diode (OLED) display.

According to an example embodiment, the display 140 may include a touch screen, for example, and may receive touch, gesture, proximity, or hovering input by using an electronic pen or a part of the user's body. In this case, the display 140 may also be used as an input device, but is not limited thereto. In some embodiments, the electronic device 100 may include a separate input device.

According to an example embodiment, the display 140 may visually present various information to a user (for example, an operator) of the electronic device 100. According to an example embodiment, the display 140 may display content related to the user input in response to receiving the user input.

According to an example embodiment, the display 140 may display data processed by the processor 110. According to an example embodiment, when the defect type of the mask is determined by the processor 110, the display 140 may display information about the mask defect.

According to an example embodiment, the display 140 may display a graphical user interface (GUI) indicative of a result of the labeling. For example, the display 140 may display a graphical user interface (GUI) indicative of a result of the labeling of the first training data stored in the memory 120.

According to an example embodiment, the display 140 may receive user input to re-label at least one of the defect shape and the mask pattern to corresponding data while the GUI representing the result of the labeling is displayed. According to an example embodiment, the display 140 may display a GUI indicative of a result of the re-labelling.

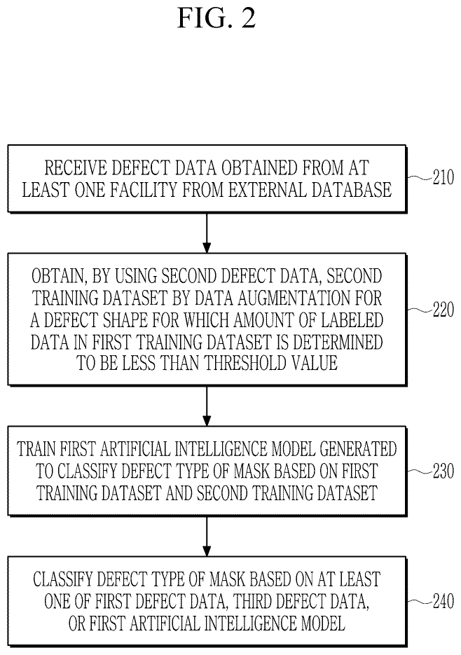

FIG. 2 is a flowchart illustrating an operating method of an electronic device according to an example embodiment.

Each of operations in FIG. 2 may be performed sequentially, but need not be performed sequentially. For example, the order of the operations may be reversed, and at least two operations may be performed in parallel. In some embodiments, some of the operations illustrated in FIG. 2 may be omitted, some operations may be combined, the order of some operations may be reversed, or other operations may be added.

Referring to FIG. 2, in operation 210, a processor (for example, the processor 110 of FIG. 1) may receive defect data obtained from the at least one facility from an external database (for example, the external database 101 of FIG. 1). The processor may receive the defect data obtained during the mask manufacturing process from the external database via a communication circuit (for example, the communication circuit 130 in FIG. 1).

For example, the defect data may include first defect data, second defect data, and third defect data obtained from separate facilities. More specifically, the processor may receive at least one of the first defect data obtained from the raw material (for example, quartz), the second defect data obtained from the mask on which the patterning process has been performed, or the third defect data obtained from the mask on which the repair process has been performed.

According to an example embodiment, the first defect data may be received from a raw material inspection facility, the second defect data may be received from an inspection facility of a mask on which a patterning process has been performed, and the third defect data may be received from an inspection facility of a mask on which a repair process has been performed.

In operation 220, the processor may obtain, by using the second defect data, a second training dataset by data augmentation for a defect shape for which the amount of labeled data in the first training dataset is determined to be less than a threshold value. For example, the second defect data may include a scanning electron microscope (SEM) image and/or a graphic design system (GDS) image obtained from a mask. Hereinafter, for illustration, the second defect data is described as including an SEM image.

According to an example embodiment, the memory may store a first training dataset for training the first artificial intelligence model. Specifically, the first training dataset may include image data labelled with a defect shape and a mask pattern.

In an embodiment, the processor may determine a defect shape for which the amount of labeled data in the first training dataset is determined to be less than a threshold value. For example, the processor may determine that the amount of labeled data for a first defect shape among the data included in the first training dataset is less than the threshold value. Alternatively, for example, the processor may determine that the amount of data labeled for the first defect shape among the data included in the first training dataset is less than the amount of data labeled for defect shapes other than the first defect shape.

According to an example embodiment, the processor may perform data augmentation for the defect shape for which the amount of labeled data is determined to be less than the threshold value. For example, the processor may perform data augmentation for the first defect shape when the amount of labeled data for the first defect shape is determined to be less than the threshold value. Alternatively, for example, the processor may perform data augmentation for the first defect shape when the processor determines that the amount of data labeled for the first defect shape among the data included in the first training dataset is less than the amount of data labeled for defect shapes other than the first defect shape.

According to an example embodiment, the processor may perform data augmentation by synthesizing an image of the first defect shape for which the amount of labeled data is determined to be less than the threshold value and an image of at least one mask pattern.

According to an example embodiment, the processor may perform masking on an SEM image of the first defect shape for which the amount of labeled data is determined to be less than the threshold value. According to an example embodiment, the SEM image of the first defect shape may be obtained from a facility for inspecting the mask on which the patterning process has been performed.

According to an example embodiment, the processor may perform masking on the SEM image to extract (or obtain) an image of the first defect shape.

According to an example embodiment, the processor may perform data augmentation by synthesizing at least one mask pattern image onto the image of the first defect shape. For example, the processor may perform data augmentation by synthesizing various mask pattern images onto the defect image of the first defect shape.

According to an example embodiment, the processor may perform data augmentation on the defect image of the first defect shape to obtain an augmented image. According to an example embodiment, the processor may configure the augmented image as a second training dataset for use as training data and store the second training dataset in the memory.

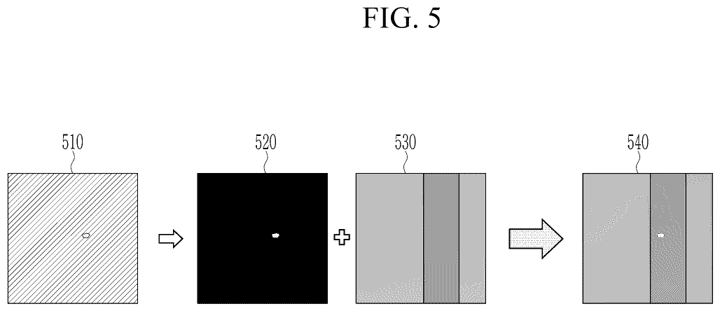

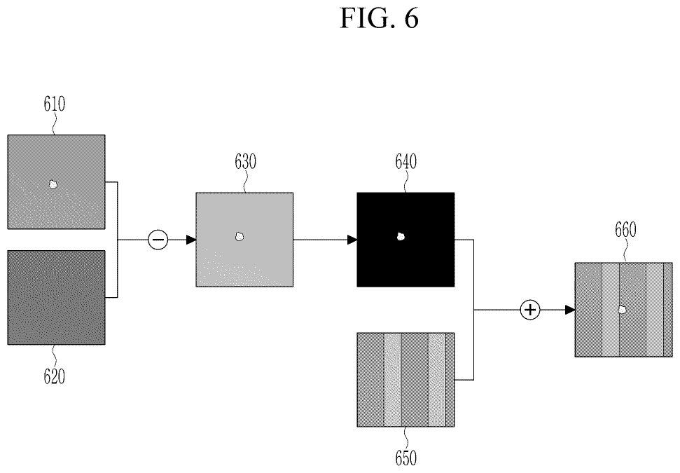

Specific details regarding example embodiments of the method of obtaining, by the electronic device according to the disclosure, the second training dataset through data augmentation will be described below with reference to FIGS. 5 and 6.

In operation 230, the processor may train a first artificial intelligence model generated to classify a defect type of the mask based on the first training dataset and the second training dataset.

According to an example embodiment, the processor may generate the first artificial intelligence model to classify the defect type of the mask by using an image dataset labeled with a defect shape and a mask pattern as training data.

According to an example embodiment, the processor may store the first artificial intelligence model generated to classify the defect type of the mask in the memory (for example, the memory 120 of FIG. 1).

According to an example embodiment, the processor may train the first artificial intelligence model to classify a defect type of the mask by using the first training dataset labeled with the defect shape and the mask pattern and the second training dataset obtained through data augmentation as training data.

According to an example embodiment, the first artificial intelligence model may be implemented to include various types of deep learning networks. According to an example embodiment, the first artificial intelligence model may perform transfer learning using a second artificial intelligence model that is a pre-trained model. According to an example embodiment, the second artificial intelligence model may include, but is not limited to, ResNet 50, a type of convolutional neural network (CNN).

According to an example embodiment, the processor may train the first artificial intelligence model by fine-tuning weight parameters of the second artificial intelligence model pre-trained by using an image dataset (for example, ImageNet data) to the first artificial intelligence model. Specifically, the processor may fine-tune the weight parameters of the second artificial intelligence model pre-trained to classify the category of the image by using the image dataset to the first artificial intelligence model.

As described above, the electronic device according to the disclosure may improve data consistency by training an artificial intelligence model through transfer learning using a pre-trained model.

According to an example embodiment, the processor may train the first artificial intelligence model by applying a focal loss function. The focal loss function is used as a loss function to resolve data imbalance, which in the electronic device according to the disclosure may be used to resolve data imbalance due to a tendency for mask defects to occur. According to an example embodiment, the processor may use a method of giving a weight value to learning by relatively increasing a loss value for data that is difficult to be classified by applying the focal loss function during the training of the first artificial intelligence model.

According to an example embodiment, the processor may train the first artificial intelligence model by applying label-smoothing. Label smoothing is a regularization technique that smooths hard labels into soft labels to reduce overconfidence in deep learning predictions. According to an example embodiment, the processor may reduce an impact of label errors on model consistency by applying label smoothing when training the first artificial intelligence model.

In operation 240, the processor may classify a defect type of the mask based on at least one of the first defect data, the third defect data, or the first artificial intelligence model.

According to an example embodiment, the processor may classify a defect type of the mask based on the defect data. According to an example embodiment, the processor may classify the defect type of the mask based on at least one of first defect data obtained from the raw material and the third defect data obtained from the mask on which a repair process has been performed.

According to an example embodiment, the processor may obtain information about at least one of a height of the defect and a location of the defect based on the first defect data. For example, the information about the height of the defect may include information about a layer in which the defect is located.

According to an example embodiment, based on the third defect data, the processor may obtain information about at least one of natural disappearance of the defect, a repair method, a repair facility, and post-repair defect disappearance.

According to an example embodiment, when the processor determines that it is unable to classify the defect type of the mask based on the first defect data, the processor may classify the defect type of the mask based on cleaning result information (e.g., information related to cleaning of the mask) included in the third defect data. For example, the processor may determine whether the defect in the mask is a stain defect based on the cleaning result information included in the third defect data.

According to an example embodiment, the processor may classify the defect type of the mask based on the first artificial intelligence model. According to an example embodiment, when the processor obtains image data (for example, second defect data) of the mask defect, the processor may classify the defect type of the mask by using the first artificial intelligence model trained to classify the defect type of the mask based on the first training dataset and the second training dataset.

According to an example embodiment, the processor may classify the defect type of the mask based on the first artificial intelligence model when it is determined that the defect type of the mask cannot be classified based on at least one of the first defect data or the third defect data.

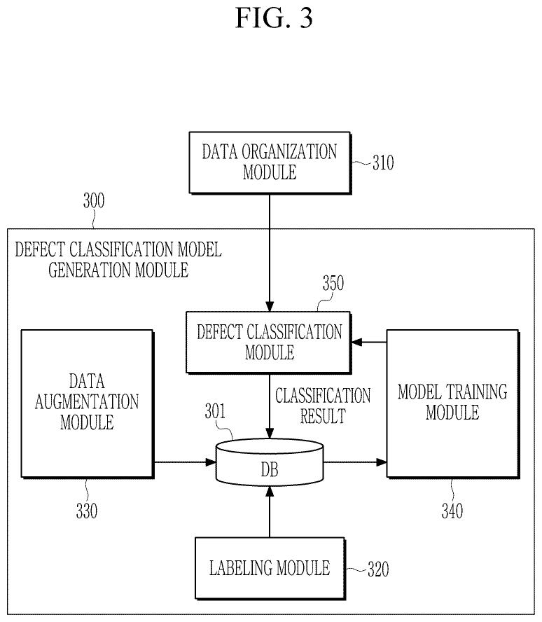

FIG. 3 is a block diagram of a program module executed by an electronic device according to an example embodiment.

Referring to FIG. 3, the electronic device (for example, the electronic device 100 of FIG. 1) or the processor (for example, the processor 110 of FIG. 1) according to an example embodiment may include a defect classification model generation module 300 and a data organization module 310. The defect classification model generation module 300 may include a labeling module 320, a data augmentation module 330, a model training module 340, and a defect classification module 350. In some embodiments, the processor may omit at least one of the above-described components or may additionally include other components.

According to an example embodiment, the defect classification model generation module 300, the data organization module 310, the labeling module 320, the data augmentation module 330, the model training module 340, and the defect classification module 350 may represent a refinement of the functions executed by the processor 110. The operations of the defect classification model generation module 300, the data organization module 310, the labeling module 320, the data augmentation module 330, the model learning module 340, and the defect classification module 350 described below may be operations performed by the electronic device 100 as instructions stored in the memory 120 are executed by the processor 110.

According to an example embodiment, the data organization module 310 may configure a data flow to make the defect data available to the defect classification model generation module 300. More specifically, the data organization module 310 may configure the data flow to make the defect data available to the defect classification module 350 included in the defect classification model generation module 300. For example, the data organization module 310 may identify, classify, generate, or transform the transceived data.

According to an example embodiment, the data organization module 310 may configure the data flow to make meta-parameters obtained during the mask manufacturing process available to the defect classification model generation module 300 for defect classification.

According to an example embodiment, the data organization module 310 may obtain first defect data from a raw material inspection facility. According to an example embodiment, the data organization module 310 may obtain the first defect data, in a form of a meta-parameter, from an inspection facility used for inspection of an incoming raw material.

For example, the first defect data may include defect information present in the raw material, for example, quartz. More specifically, for example, the first defect data may include information about at least one of a size of a defect present in the raw material, coordinates of a location of the defect, and a layer in which the defect is located.

According to an example embodiment, the data organization module 310 may obtain second defect data from an inspection facility used for post-patterning inspection. For example, the second defect data may include information about at least one of a defect image (for example, an SEM image), a defect size, or coordinates of the location of the defect.

According to an example embodiment, the data organization module 310 may obtain third defect data from a repair process facility. For example, the third defect data may include information about at least one of the following: whether the defect naturally disappears, a repair method, a repair facility, or whether the defect disappears after repair.

According to an example embodiment, the data configuration module 310 may transmit a meta-parameter obtained during the mask manufacturing process to the defect classification model generation module 300.

As described above, the electronic device according to the disclosure may improve the accuracy of defect classification by estimating the layer in which the defect is located through the meta-parameter.

According to an example embodiment, the defect classification model generation module 300 may include the labeling module 320, the data augmentation module 330, the model training module 340, and the defect classification module 350. However, the disclosure is not limited thereto, and one or more modules described above as being included in the defect classification model generation module 300 may be provided separately from the defect classification model generation module 300.

According to an example embodiment, the labeling module 320 may generate a database with labels and store the labels in a database 301. For example, the labels may include a defect shape and a mask pattern. According to an example embodiment, the labeling module 320 may store the labeled data in the database 301.

According to an example embodiment, the labeling module 320 may be operatively coupled to a display (for example, the display 140 of FIG. 1). According to an example embodiment, the labeling module 320 may provide a labeling user interface (UI) to a user via the display. According to an example embodiment, the labeling module 320 may display a graphical user interface (GUI) representing the labeled data via the display. According to an example embodiment, the labeling module 320 may perform re-labeling based on a user input received while the GUI is displayed.

According to an example embodiment, the data augmentation module 330 may determine a defect shape in which the amount of labeled data is determined to be less than a threshold value, among the labeled data stored in the memory (e.g., the memory 120 of FIG. 1 and/or the database 301). For example, the data augmentation module 330 may determine that the amount of labeled data for the first defect shape is less than the threshold value. Alternatively, for example, the data augmentation module 330 may determine that the amount of data labeled for the first defect shape is less than the amount of data labeled for defect shapes other than the first defect shape.

According to an example embodiment, the data augmentation module 330 may perform data augmentation for the defect shape for which the amount of labeled data is determined to be less than the threshold value. For example, the data augmentation module 330 may perform data augmentation for the first defect shape when the amount of labeled data for the first defect shape is determined to be less than the threshold value. Alternatively, for example, the data augmentation module 330 may perform data augmentation for the first defect shape when the amount of data labeled for the first defect shape is determined to be less than the amount of data labeled for defect shapes other than the first defect shape.

According to an example embodiment, the data augmentation module 330 may perform data augmentation by synthesizing an image of the first defect shape for which the amount of labeled data is determined to be less than the threshold value and an image of at least one mask pattern. For example, the data augmentation module 330 may obtain a large amount of data by synthesizing an image of the first defect shape for which the amount of labeled data is determined to be less than the threshold value and various mask pattern images.

According to an example embodiment, the data augmentation module 330 may store the data obtained through data augmentation in the database 301. According to an example embodiment, the data augmentation module 330 may organize the data obtained through the data augmentation into datasets for use by the artificial intelligence model as training data and store the datasets in the database 301.

As described above, the electronic device according to the disclosure may obtain a sufficient amount of labeled data through the data augmentation to maintain predictive performance in the event of a defect in a new mask pattern.

Furthermore, as discussed above, the electronic device according to the disclosure may generate clearer image data by performing data augmentation through image generation with masking.

According to an example embodiment, the model training module 340 may train an artificial intelligence model to classify defect types in the mask based on the data stored in the database 301. For example, the data stored in the database 301 may include the data labeled by the labeling module 320 and/or the data generated by the data augmentation module 330. More specifically, the data stored in the database 301 may include an image dataset labeled with defect shapes and mask patterns.

According to an example embodiment, the model training module 340 may train the artificial intelligence model to classify the defect type of the mask by using an image dataset labeled with a defect shape and a mask pattern as training data.

According to an example embodiment, the artificial intelligence model to classify the defect type of the mask may be implemented to include various types of deep learning networks. According to an example embodiment, the artificial intelligence model for classifying the defect type of the mask may perform transfer learning using a pre-trained model. According to an example embodiment, the pre-trained model may use, for example but is not limited to, ResNet 50, a type of convolutional neural network (CNN).

According to an example embodiment, the model training module 340 may train the artificial intelligence model by fine-tuning weight parameters of the pre-trained model pre-trained by using the image dataset (for example, ImageNet data) onto the artificial intelligence model for classifying defect types of the mask. Specifically, the model training module 340 may fine-tune the weight parameters of the pre-trained model that is pre-trained to classify categories of images by using the image dataset into the artificial intelligence model that classifies defect types of masks.

According to an example embodiment, the model training module 340 may train an artificial intelligence model to classify the defect type of the mask by applying a focal loss function. The focal loss function is used as a loss function to resolve data imbalance, which in the electronic device according to the disclosure may be used to resolve data imbalance due to a tendency for mask defects to occur. According to an example embodiment, the model training module 340 may use a method of giving a weight value to training by relatively increasing a loss value for data that is difficult to classify by applying the focal loss function during the training of the first artificial intelligence model.

According to an example embodiment, the model training module 340 may train an artificial intelligence model by applying label-smoothing. Label smoothing is a regularization technique that smooths hard labels into soft labels to reduce overconfidence in deep learning predictions. According to an example embodiment, the model training module 340 may reduce an impact of label errors on model consistency by applying label smoothing when training the artificial intelligence model.

According to an example embodiment, the defect classification module 350 may predict defect types based on the data obtained from the data organization module 310.

According to an example embodiment, the defect classification module 350 may classify (or determine) defect types by using meta-parameters (for example, the first defect data, the second defect data, and/or the third defect data) obtained during the mask manufacturing process in addition to the second defect data (for example, SEM images).

According to an example embodiment, the defect classification module 350 may identify at least one of height information of a defect in the mask or location information of a defect in the mask based on the first defect data obtained from the data organization module 310. According to an example embodiment, the defect classification module 350 may predict a defect type based on at least one of the height information of the defect in the mask or the location information of the defect in the mask.

According to an example embodiment, the defect classification module 350 may identify cleaning result information of the mask based on the third defect data obtained from the data organization module 310. For example, the cleaning result information may include at least one of facility environment information or repair history related to the mask.

According to an example embodiment, the defect classification module 350 may predict a defect type based on the cleaning result information of the mask. For example, the defect classification module 350 may determine whether the defect on the mask is a stain based on the cleaning result information of the mask.

According to an example embodiment, the defect classification module 350 may classify (or predict) the defect type of the mask based on the artificial intelligence model trained by the model training module 340. According to an example embodiment, the defect classification module 350 may classify the defect type of the mask based on the artificial intelligence model trained by the model learning module 340 when it is determined that the defect type of the mask cannot be classified based on at least one of the first defect data or the third defect data.

According to an example embodiment, the defect classification module 350 may store result data according to the classification of the detect type of the mask in the database 301. According to an example embodiment, the data stored in the database 301 by the defect classification module 350 may be target data that is later labeled by a user.

As described above, the electronic device according to the disclosure may improve a speed of a defect prediction model (or defect classification model) by classifying defect types by using meta-parameters obtained during the mask manufacturing process in addition to SEM images.

As described above, the electronic device according to the disclosure may improve reliability in classifying defect types by using meta-parameters obtained during the mask manufacturing process in addition to SEM images, which reflect advanced mask manufacturing process information.

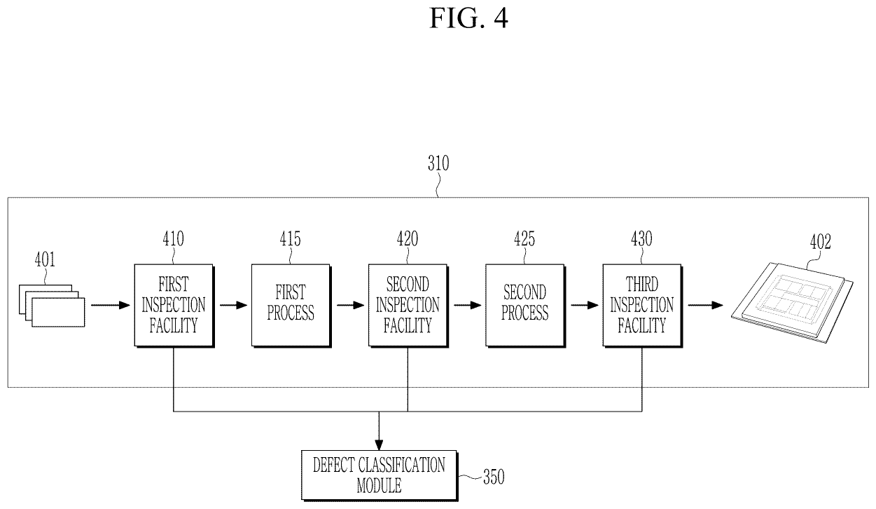

FIGS. 4 to 7 are diagrams for illustrating operations of an electronic device according to an example embodiment.

Referring to FIG. 4, in the electronic device according to an example embodiment, the data organization module 310 may configure a data flow to make defect data available to the defect classification module 350. In the following embodiments, duplicative descriptions of those previously described with reference to FIGS. 1 to 3 will be omitted, and only differences will be described in detail. The same reference numerals may be given to configurations identical to those of the electronic device according to an example embodiment of the disclosure described above.

According to an example embodiment, the data organization module 310 may configure data flows to make defect data available to the defect classification module 350. For example, the data organization module 310 may identify, classify, generate, or transform the transceived data.

According to an example embodiment, the data organization module 310 may configure the data flow to make meta-parameters obtained during the mask manufacturing process available to the defect classification module 350 for defect classification.

According to an example embodiment, the data organization module 310 may obtain the first defect data in a form of a meta-parameter from a first inspection facility 410 used in incoming inspection of a raw material 401. For example, the first inspection facility 410 may detect a defect present in the raw material 401.

For example, the first defect data may include defect information present in the raw material 401, for example, quartz. More specifically, for example, the first defect data may include information about at least one of a size of a defect present in the raw material 401, coordinates of a location of the defect, and a layer in which the defect is located.

According to an example embodiment, the data organization module 310 may obtain the second defect data in a form of a meta-parameter from a second inspection facility 420 that inspects a mask on which a first process 415 has been performed. For example, the first process 415 may correspond to a patterning process. For example, the second inspection facility 420 may detect a defect present in a mask on which the first process 415 has been performed. For example, the second defect data may include information about at least one of a defect image (for example, SEM image), a defect size, and coordinates of a location of the defect.

According to an example embodiment, the data organization module 310 may obtain the third defect data in a form of a meta-parameter from a third inspection facility 430 that inspects a mask on which a second process 425 has been performed. For example, the second process 425 may correspond to a repair process. For example, the third inspection facility 430 may detect a defect present in the mask on which the second process 425 has been performed. For example, the third defect data may include information about at least one of the following: whether the defect naturally disappears, a repair method, a repair facility, or whether the defect disappears after repair.

According to an example embodiment, the data organization module 310 may transmit meta-parameters (for example, the first defect data, the second defect data, and the third defect data) obtained during a mask manufacturing process of a mask 402 to the defect classification module 350.

Referring to FIG. 5, in the electronic device according to an example embodiment, a data augmentation module (for example, the data augmentation module 330 of FIG. 3) may perform data augmentation for a specific defect shape. In the following embodiments, duplicative descriptions of those previously described with reference to FIGS. 1 to 3 will be omitted, and only differences will be described in detail. The same reference numerals may be given to configurations identical to those of the electronic device according to an example embodiment of the disclosure described above.

According to an example embodiment, the data augmentation module 330 may perform masking on an SEM image 510 of a first defect shape for which the amount of labeled data is determined to be less than a threshold value. According to an example embodiment, the SEM image 510 of the first defect shape may be obtained from a facility for inspecting the mask on which the patterning process has been performed.

According to an example embodiment, the data augmentation module 330 may perform masking on the SEM image 510 to extract (or obtain) a defect image 520 of the first defect shape.

According to an example embodiment, the data augmentation module 330 may perform data augmentation by synthesizing at least one mask pattern image 530 onto the defect image 520 of the first defect shape. For example, the data augmentation module 330 may perform data augmentation by synthesizing various mask pattern images 530 onto the defect image 520 of the first defect shape.

According to an example embodiment, the data augmentation module 330 may perform data augmentation on the defect image 520 of the first defect shape to obtain an augmented image 540. According to an example embodiment, the data augmentation module 330 may store the augmented image 540 in a database (for example, the database 301 of FIG. 3) so that a model training module (for example, the model training module 340 of FIG. 3) may utilize the augmented image 540 as training data.

As described above, the electronic device according to the disclosure may improve consistency of the learning model by obtaining a sufficient amount of labeled data through data augmentation.

Furthermore, as discussed above, the electronic device according to the disclosure may generate clearer image data by performing data augmentation through image generation with masking.

Referring to FIG. 6, in the electronic device according to an example embodiment, a data augmentation module (for example, the data augmentation module 330 of FIG. 3) may perform data augmentation by a method of synthesizing at least one mask pattern image onto a specific defect shape. In the following embodiments, duplicative descriptions of those previously described with reference to FIGS. 1 to 3 will be omitted, and only differences will be described in detail. The same reference numerals may be given to configurations identical to those of the electronic device according to an example embodiment of the disclosure described above.

According to an example embodiment, the data augmentation module may obtain a difference image 630 by subtracting an SEM image 610 of the first defect shape for which the amount of labeled data is determined to be less than a threshold value from a normal pattern image 620. For example, the normal pattern image 620 may correspond to an image in which no defect is present.

According to an example embodiment, the data augmentation module may multiply (or synthesize) a defect mask generated based on the difference image 630 with the SEM image 610 of the first defect shape to generate a defect image 640 of the first defect shape.

According to an example embodiment, the data augmentation module may synthesize the defect image 640 of the first defect shape and at least one mask pattern image 650 to generate augmented data 660. For example, the data augmentation module may generate the augmented data 660 by synthesizing various mask pattern images to the defect image 640 of the first defect shape.

As described above, the electronic device according to the disclosure may augment data by synthesizing various mask pattern images to the same defect image to obtain a sufficient amount of data required for defect classification.

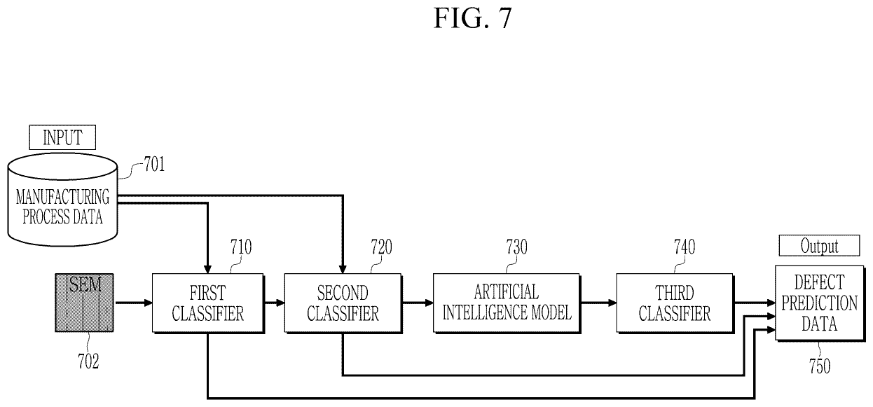

Referring to FIG. 7, in the electronic device according to an example embodiment, a defect classification module (for example, defect classification module 350 of FIG. 3) may classify (or determine) a defect type of the mask based on at least one of manufacturing process data 701 and an SEM image 702 obtained during mask manufacturing. In the disclosure, the manufacturing process data 701 may include first defect data and third defect data, and the SEM image 702 may correspond to second defect data.

In the following embodiments, duplicative descriptions of those previously described with reference to FIGS. 1 to 3 will be omitted, and only differences will be described in detail. The same reference numerals may be given to configurations identical to those of the electronic device according to an example embodiment of the disclosure described above.

According to an example embodiment, the defect classification module may include a first classifier 710, a second classifier 720, an artificial intelligence model 730, and a third classifier 740. According to an example embodiment, the defect classification module may classify a defect type by using at least one of the first classifier 710, the second classifier 720, and the third classifier 740.

According to an example embodiment, the defect classification module may obtain manufacturing process data 701 and/or an SEM image 702 that are obtained during the mask manufacturing process.

According to an example embodiment, the defect classification module may predict a defect type based on the manufacturing process data 701 (for example, the first defect data, the second defect data, and/or the third defect data).

According to an example embodiment, the first classifier 710 may identify at least one of height information of the defect in the mask or location information of the defect in the mask based on the first defect data (for example, raw material inspection results) in the manufacturing process data 701. According to an example embodiment, the first classifier 710 may predict the type of defect occurring in a multi-layer based on at least one of the height information of the defect in the mask or the location information of the defect in the mask. According to an example embodiment, the first classifier 710 may generate defect prediction data 750 based on the defect type predicted based on the first defect data.

According to an example embodiment, the second classifier 720 may identify cleaning result information (for example, facility environment information, and repair history) of the mask based on the third defect data in the manufacturing process data 701. According to an example embodiment, the second classifier 720 may predict a defect type based on the cleaning result information of the mask. For example, the second classifier 720 may determine whether the defect on the mask is a stain based on the cleaning result information of the mask. According to an example embodiment, the second classifier 720 may predict the defect type of the mask using the third defect data, based on a determination that the defect type of the mask cannot be classified based on the first defect data. According to an example embodiment, the second classifier 720 may generate defect prediction data 750 based on the defect type predicted based on the third defect data.

According to an example embodiment, the third classifier 740 may classify the defect type of the mask based on the artificial intelligence model 730. According to an example embodiment, the artificial intelligence model 730 may classify (or predict) the defect type of the mask by using the SEM image 702. According to an example embodiment, the third classifier 740 may classify the defect type of the mask based on the artificial intelligence model 730 when it is determined that the defect type of the mask cannot be classified based on the manufacturing process data 701 (e.g., at least one of the first defect data or the third defect data). The artificial intelligence model 730 may correspond to an artificial intelligence model trained to classify defects in the mask by using a dataset labeled with defect shapes and mask patterns.

According to an example embodiment, the defect classification module may store the defect prediction data 750 predicting the defect type of the mask in a database (for example, the database 301 of FIG. 3). According to an example embodiment, the defect prediction data 750 stored in the database may be target data that is later labeled by a user.

As described above, the electronic device according to the disclosure may improve the speed of defect classification by classifying defect types by using meta-parameters obtained during the mask manufacturing process in addition to SEM images.

As described above, the electronic device according to the disclosure may improve reliability in classifying defects by reflecting advanced mask manufacturing process information (for example, facility environment information and repair history) in addition to SEM images.

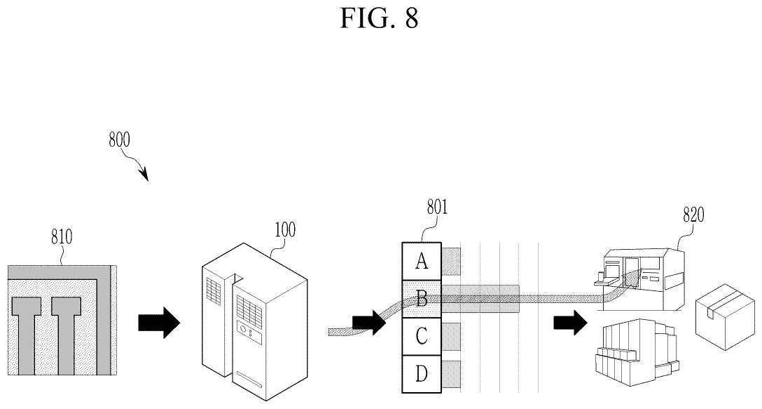

FIG. 8 is a diagram illustrating an electronic system according to an example embodiment.

Referring to FIG. 8, an electronic system 800 according to an example embodiment may include an electronic device 100, at least one inspection facility 810, and a semiconductor process facility 820.

According to an example embodiment, the electronic device 100 may be wirely or wirelessly connected to a semiconductor facility (for example, the inspection facility 810 and the semiconductor process facility 820). For example, the electronic device 100 may be wirely or wirelessly connected to the semiconductor facility via a communication circuit (for example, the communication circuit 130 of FIG. 1).

According to an example embodiment, at least one inspection facility 810 may include at least one inspection facility for detecting mask defects. According to an example embodiment, at least one inspection facility 810 may include a facility for detecting defects in raw materials or in masks on which at least one process has been performed. For example, the at least one inspection facility 810 may include at least one of an inspection facility for detecting defects in raw materials, an inspection facility for detecting defects in masks on which a patterning process has been performed, or an inspection facility for detecting defects in masks on which a repair process has been performed. According to an example embodiment, the at least one inspection facility 810 may be in wireless communication with the electronic device 100.

According to an example embodiment, the electronic device 100 may generate defect prediction data 801 based on at least one of defect data obtained from the at least one inspection facility 810 and an artificial intelligence model trained to classify a defect type of the mask. For example, the electronic device 100 may generate the defect prediction data 801 indicating that, among A defect type, B defect type, C defect type, and D defect type, the defect type of the mask is determined to be B defect type. According to an example embodiment, the electronic device 100 may transmit the generated defect prediction data 801 to the semiconductor process facility 820.

According to an example embodiment, the semiconductor process facility 820 may communicate wirely or wirelessly with the electronic device 100. For example, the semiconductor process facility 820 may receive defect prediction data 801 from the electronic device 100. According to an example embodiment, the semiconductor process facility 820 may automatically perform a repair process based on the received defect prediction data 801. According to an example embodiment, the semiconductor process facility 820 may select a repair process based on the received defect prediction data 801. According to another embodiment, the semiconductor process facility 820 may determine a non-defect and select releasing of a product based on the received defect prediction data 801.

As described above, the electronic system according to the disclosure may automate the repair process based on the defect type of the mask by associating the result of the determination of the defect type of the mask with the semiconductor process facility.

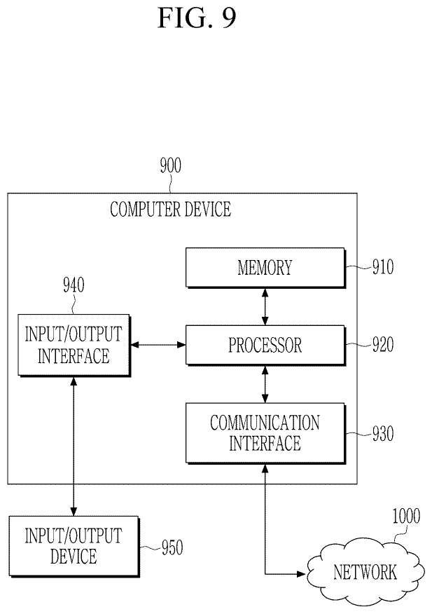

FIG. 9 is a drawing illustrating an example of a computer device implementing an electronic device according to an example embodiment. The electronic device 100 of FIG. 1 may be implemented by a computer device 900 illustrated in FIG. 9.

Referring to FIG. 9, the computer device 900 may include a memory 910, a processor 920, a communication interface 930, and an input/output interface 940.

The memory 910 is a computer-readable recording medium, which may include a random access memory (RAM), a read only memory (ROM), and a permanent mass storage device such as a disk drive. Additionally, the memory 910 may store an operating system and at least one program code. These software components may be loaded into the memory 910 from a computer-readable recording medium that is separate from the memory 910. The separate computer-readable recording medium may include a computer-readable recording medium, such as a hard disk, flash memory, optical disk, external hard disk, or the like. Additionally, these software components may be loaded into the memory 910 via the communication interface 930.

The processor 920 may be configured to process instructions from a computer program by performing basic arithmetic, logic, and input/output operations. The instructions may be provided to the processor 920 by the memory 910 or by the communication interface 930.

The communication interface 930 may provide functionality for the computer device 900 to communicate with other devices and with each other over the network 1000. Communication methods are not limited and may include short-range wireless communication between devices as well as communication methods utilizing a communication network (for example, a cellular network, wired internet, wireless internet, or broadcast network) that the network 1000 may include. For example, the network 1000 may include any one or more of networks, such as a personal area network (PAN), a local area network (LAN), a campus area network (CAN), a metropolitan area network (MAN), a wide area network (WAN), a broadband network (BBN), and the Internet. The network 1000 may also include any one or more of network topology including, but not limited to, a bus network, a star network, a ring network, a mesh network, a star-bus network, a tree or hierarchical network, and the like.

The input/output interface 940 may serve as an interface that may transmit instructions or data input from the user or an input/output device 950 to other component(s) of the computer device 900. In addition, the input/output interface 940 may output commands or data received from the other component(s) of the computer device 900 to the user or the input/output device 950. For example, the input/output device 950 may include an input device, such as a microphone, a keyboard, or a mouse, and an output device, such as a display or a speaker.

The example embodiments described above may be implemented in the form of computer programs that may be executable by various components on a computer, and such programs may be recorded on a computer-readable medium. The medium may include magnetic media such as hard disks, floppy disks, and magnetic tapes, optical recording media such as CD-ROMs and DVDs, magneto-optical media such as floptical disks, and hardware devices specifically configured to store and execute program instructions, such as ROM, RAM, flash memory, and the like.

The operations configuring the method according to an example embodiment may be performed in any order, provided that no order is expressly stated or implied. The order in which the operations are described does not necessarily limit the disclosure.

All examples or use of terms in this specification are intended merely to illustrate the disclosure in detail and are not intended to limit the scope of the disclosure. Further, those skilled in the art may recognize that various modifications, combinations, and changes may be made within the scope of the patent claims or equivalents thereof.

At least one of the components, elements, modules and units (collectively “components” in this paragraph) represented by a block or an equivalent indication in the drawings described above may use a direct circuit structure, such as a memory, a processor, a logic circuit, a look-up table, etc. that may execute the respective functions through controls of one or more microprocessors or other control apparatuses. Alternatively or additionally, at least one of these components may be specifically embodied by a module, a program, or a part of code, which is stored in an internal memory or an external memory of the electronic device, and contains one or more executable instructions for performing the above-described functions, and executed by one or more microprocessors or other control apparatuses. Further, at least one of these components may include or may be implemented by a processor such as a central processing unit (CPU), graphic processing unit (GPU), another type of microprocessor, or the like that performs the above-described functions. Two or more of these components may be combined into one single component which performs all operations or functions of the combined two or more components. Also, at least part of functions of at least one of these components may be performed by another of these components. Functional aspects of the above example embodiments may be implemented in algorithms that execute on one or more processors.

Although an example embodiment(s) has been described in detail, the scope of the disclosure is not limited by the example embodiment(s). Various changes and modifications using the basic concept of the disclosure defined in the accompanying claims by those skilled in the art shall be construed to belong to the scope of the disclosure.

What is claimed is:

1. An electronic device comprising:
a communication circuit;
a memory configured to store a first training dataset and at least one artificial intelligence model, the first training dataset being labeled with a defect shape and a mask pattern of a mask; and
at least one processor operatively connected to the communication circuit and the memory,
wherein the at least one processor is configured to:
receive, from an external database via the communication circuit, defect data obtained from at least one facility, the defect data including first defect data, second defect data, and third defect data;
by using the second defect data, obtain a second training dataset by performing data augmentation on a defect shape for which an amount of labeled data in the first training dataset is determined to be less than a threshold value;
train a first artificial intelligence model generated to classify a defect type of a mask based on the first training dataset and the second training dataset; and
classify a defect type of a mask based on at least one of the first defect data, the third defect data, or the first artificial intelligence model.

2. The electronic device of claim 1, wherein the at least one processor is configured to classify the defect type of the mask based on the first artificial intelligence model, based on a determination that the defect type of the mask fails to be classified based on at least one of the first defect data or the third defect data.

3. The electronic device of claim 1, wherein the second defect data is obtained from a mask from which the first defect data was obtained and on which at least one unit process was performed, and
wherein the third defect data is obtained from a mask from which the second defect data was obtained and on which at least one unit process was performed.

4. The electronic device of claim 1, wherein the at least one processor is configured to classify the defect type of the mask based on at least one of height information of a defect of the mask or location information of the defect of the mask, the at least one of the height information or the location information being included in the first defect data.

5. The electronic device of claim 3, wherein the at least one processor is configured to classify the defect type of the mask based on the third defect data, based on a determination that the defect type of the mask fails to be classified based on the first defect data.

6. The electronic device of claim 1, further comprising:
a display,
wherein the at least one processor is configured to:
control the display to display a graphical user interface (GUI) representing labeled data through the display, and
perform re-labeling based on a user input received while the GUI is displayed.

7. The electronic device of claim 6, wherein the at least one processor is configured to update the first artificial intelligence model based on a relabeled dataset based on a determination that the defect type of the mask classified by using the first artificial intelligence model is different from a defect type pre-stored for the mask.

8. The electronic device of claim 1, wherein the at least one processor is further configured to obtain the second training dataset by performing data augmentation that synthesizes an image of the defect shape, for which the amount of labeled data is determined to be less than the threshold value, and an image of at least one mask pattern.

9. The electronic device of claim 1, wherein the at least one processor is configured to train the first artificial intelligence model by fine-tuning a weight parameter of a second artificial intelligence model, which is pre-trained by using an image dataset, to the first artificial intelligence model.

10. The electronic device of claim 1, wherein the at least one processor is configured to train the first artificial intelligence model by applying a focal loss function.

11. The electronic device of claim 1, wherein the at least one processor is configured to train the first artificial intelligence model by applying label-smoothing.

12. An operating method of an electronic device including a communication circuit, a memory configured to store a first training dataset labeled with a defect shape and a mask pattern of a mask, and at least one processor operatively connected to the communication circuit and the memory, the operating method comprising:
receiving, via the communication circuit, defect data obtained from at least one facility from an external database, the defect data including first defect data, second defect data, and third defect data;
by using the second defect data, obtaining a second training dataset by performing data augmentation on a defect shape for which an amount of labeled data in the first training dataset is determined to be less than a threshold value;
training a first artificial intelligence model generated to classify a defect type of a mask based on the first training dataset and the second training dataset; and
classifying a defect type of a mask based on at least one of the first defect data, the third defect data, or the first artificial intelligence model.

13. The operating method of claim 12, wherein the classifying includes:
classifying the defect type of the mask based on the first artificial intelligence model, based on a determination that the defect type of the mask fails to be classified based on at least one of the first defect data or the third defect data.

14. The operating method of claim 12, wherein the second defect data is obtained from a mask from which the first defect data was obtained and on which at least one unit process was performed, and
wherein the third defect data is obtained from a mask from which the second defect data was obtained and on which at least one unit process was performed.

15. The operating method of claim 12, wherein the classifying includes:
classifying the defect type of the mask based on at least one of height information of a defect of the mask or location information of the defect of the mask, the at least one of the height information or the location information being included in the first defect data.

16. The operating method of claim 14, wherein the classifying of the defect type of the mask includes:
classifying the defect type of the mask based on the third defect data, based on a determination that the defect type of the mask fails to be classified based on the first defect data.

17. The operating method of claim 12, wherein the training includes:
training the first artificial intelligence model by fine-tuning a weight parameter of a second artificial intelligence model, which is pre-trained by using an image dataset, to the first artificial intelligence model.

18. The operating method of claim 12, wherein the training includes:
training the first artificial intelligence model by applying a focal loss function.

19. The operating method of claim 12, wherein the training includes:
training the first artificial intelligence model by applying label-smoothing.

20. An electronic system comprising:
an electronic device including a processor, a memory, and a communication circuit;
at least one inspection facility configured to inspect a defect related to a mask; and
a semiconductor process facility configured to process a process based on mask defect information,
wherein the electronic device is configured to predict a defect type of the mask based on at least one of manufacturing process data of the mask, received from the at least one inspection facility, or an artificial intelligence model trained to classify a defect type of the mask, and transmit defect prediction data for the predicted defect type to the semiconductor process facility, and
wherein the semiconductor process facility is configured to perform a process according to the defect prediction data.
